(19) United States
(12) Patent Application Publication
(10) Pub. No.: US 2025/0247901 A1
(43) Pub. Date: Jul. 31, 2025

(54) TECHNIQUES FOR COMMUNICATING DATA

(71) Applicant: Apple Inc., Cupertino, CA (US)

(72) Inventors: Alejandro A. RODRIGUEZ, Saratoga, CA (US); Gordon Y. SCOTT, Cupertino, CA (US); Ho Cheung CHUNG, San Jose, CA (US); Pablo PONS BORDES, Redwood City, CA (US); Sreekuttan SUDARSANAN, San Francisco, CA (US); Christian SEIFERT, Cupertino, CA (US); Raj LUHAR, Cupertino, CA (US)

(21) Appl. No.: 19/082,365

(22) Filed: Mar. 18, 2025

Related U.S. Application Data
(63) Continuation of application No. 18/665,270, filed on May 15, 2024, now abandoned.
(60) Provisional application No. 63/545,529, filed on Oct. 24, 2023.
(60) Provisional application No. 63/471,185, filed on Jun. 5, 2023.

(51) Int. Cl. H04W 76/10; H04W 4/12; H04W 12/047; H04W 12/06

(52) U.S. Cl. CPC H04W 76/10; H04W 4/12; H04W 12/047; H04W 12/06

(57) ABSTRACT

The present disclosure generally relates to communicating data. Some techniques are described herein for selecting an initiator for a near-field communication (NFC). Such techniques include comparing a random number generated to a random message received in a polling message to select an initiator for NFC. NFC is then used to transfer data to be used to establish a different type of wireless communication channel, such as Wi-Fi or Bluetooth. Other techniques are described herein for selectively sending a long-term key over one communication channel for another communication channel when communicating with another device. Such techniques include receiving an authentication credential from the other device and, if the authentication credential has not previously been seen, sending the long-term key. Other techniques are described herein for selectively delaying subsequent communication with another device communication over a communication channel. Such techniques include receiving an authentication response from the other device and, if the authentication response corresponds to an unknown device, delaying subsequent communication with the other device.

### CROSS-REFERENCE TO RELATED APPLICATIONS

The present application is a continuation patent applicant of U.S. Non-Provisional patent application Ser. No. 18/665,270, entitled “TECHNIQUES FOR COMMUNICATING DATA,” filed May 15, 2024, which claims priority to U.S. Provisional Patent Application Ser. No. 63/545,529, entitled “TECHNIQUES FOR COMMUNICATING DATA” filed Oct. 24, 2023, and to U.S. Provisional Patent Application Ser. No. 63/471,185, entitled “TECHNIQUES FOR COMMUNICATING DATA” filed Jun. 5, 2023, which are hereby incorporated by reference in their entireties for all purposes.

### BACKGROUND

Electronic devices are becoming increasingly interconnected. For example, controllers (e.g., user devices and/or computer systems) are often connected to accessories (e.g., a speaker, a fan, and a thermostat) in the home or office. Allowing such devices to communicate data in a secure way can be complicated. Accordingly, there is a need to improve techniques for communicating data.

### SUMMARY

Current techniques for communicating data are generally ineffective and/or inefficient. For example, some techniques require devices to already have contact information for those that they are contacting. This disclosure provides more effective and/or efficient techniques for communicating data using an example of two smartphones communicating contact information and then a photo. It should be recognized that other types of electronic devices and other data can be used with techniques described herein. For example, a smart watch can communicate calendar data to a smart speaker for output by the smart speaker using techniques described herein. In addition, techniques optionally complement or replace other techniques for communicating data.

Some techniques are described herein for selecting an initiator for a near-field communication (NFC). Such techniques include comparing a random number generated to a random message received in a polling message to select an initiator for NFC. NFC is then used to transfer data to be used to establish a different type of wireless communication channel, such as Wi-Fi or Bluetooth. Other techniques are described herein for selectively sending a long-term key over one communication channel for another communication channel when communicating with another device. Such techniques include receiving an authentication credential from the other device and, if the authentication credential has not previously been seen, sending the long-term key. It should be recognized that techniques described herein can be modified and/or combined. For example, the long-term key can be sent over NFC to establish the different type of wireless communication channel.

In some embodiments, a method that is performed at a first device is described. In some embodiments, the method comprises: receiving, from a second device different from the first device, a polling message; and as a result of receiving the polling message: in accordance with a determination based on the polling message that the first device is selected to initiate a communication channel of a first type: initiating a first communication channel of the first type; and sending, via the first communication channel of the first type, first communication information for a communication channel of a second type; and in accordance with a determination based on the polling message that the first device is not selected to initiate a communication channel of the first type: forgoing initiating the first communication channel of the first type; and receiving, via a second communication channel of the first type, second communication information for a communication channel of the second type.

In some embodiments, a non-transitory computer-readable storage medium storing one or more programs configured to be executed by one or more processors of a first device is described. In some embodiments, the one or more programs includes instructions for: receiving, from a second device different from the first device, a polling message; and as a result of receiving the polling message: in accordance with a determination based on the polling message that the first device is selected to initiate a communication channel of a first type: initiating a first communication channel of the first type; and sending, via the first communication channel of the first type, first communication information for a communication channel of a second type; and in accordance with a determination based on the polling message that the first device is not selected to initiate a communication channel of the first type: forgoing initiating the first communication channel of the first type; and receiving, via a second communication channel of the first type, second communication information for a communication channel of the second type.

In some embodiments, a transitory computer-readable storage medium storing one or more programs configured to be executed by one or more processors of a first device is described. In some embodiments, the one or more programs includes instructions for: receiving, from a second device different from the first device, a polling message; and as a result of receiving the polling message: in accordance with a determination based on the polling message that the first device is selected to initiate a communication channel of a first type: initiating a first communication channel of the first type; and sending, via the first communication channel of the first type, first communication information for a communication channel of a second type; and in accordance with a determination based on the polling message that the first device is not selected to initiate a communication channel of the first type: forgoing initiating the first communication channel of the first type; and receiving, via a second communication channel of the first type, second communication information for a communication channel of the second type.

In some embodiments, a first device is described. In some embodiments, the first device comprises one or more processors and memory storing one or more programs configured to be executed by the one or more processors. In some embodiments, the one or more programs includes instructions for: receiving, from a second device different from the first device, a polling message; and as a result of receiving the polling message: in accordance with a determination based on the polling message that the first device is selected to initiate a communication channel of a first type: initiating a first communication channel of the first type; and sending, via the first communication channel of the first type, first communication information for a communication channel of a second type; and in accordance with a determination based on the polling message that the first device is not selected to initiate a communication channel of the first type: forgoing initiating the first communication channel of the first type; and receiving, via a second communication channel of the first type, second communication information for a communication channel of the second type.

In some embodiments, a first device is described. In some embodiments, the first device comprises means for performing each of the following steps: receiving, from a second device different from the first device, a polling message; and as a result of receiving the polling message: in accordance with a determination based on the polling message that the first device is selected to initiate a communication channel of a first type: initiating a first communication channel of the first type; and sending, via the first communication channel of the first type, first communication information for a communication channel of a second type; and in accordance with a determination based on the polling message that the first device is not selected to initiate a communication channel of the first type: forgoing initiating the first communication channel of the first type; and receiving, via a second communication channel of the first type, second communication information for a communication channel of the second type.

In some embodiments, a computer program product is described. In some embodiments, the computer program product comprises one or more programs configured to be executed by one or more processors of a first device. In some embodiments, the one or more programs include instructions for: receiving, from a second device different from the first device, a polling message; and as a result of receiving the polling message: in accordance with a determination based on the polling message that the first device is selected to initiate a communication channel of a first type: initiating a first communication channel of the first type; and sending, via the first communication channel of the first type, first communication information for a communication channel of a second type; and in accordance with a determination based on the polling message that the first device is not selected to initiate a communication channel of the first type: forgoing initiating the first communication channel of the first type; and receiving, via a second communication channel of the first type, second communication information for a communication channel of the second type.

In some embodiments, a method that is performed at a first device is described. In some embodiments, the method comprises: receiving, from a second device different from the first device via a first communication channel, an authentication credential; in response to receiving the authentication credential: in accordance with a determination that a first set of one or more criteria is satisfied, wherein the first set of one or more criteria includes a criterion that is satisfied when the authentication credential has not been previously received by the first device, sending, to the second device via the first communication channel, a set of one or more keys, wherein a key of the set of one or more keys corresponds to a second communication channel not currently established; and in accordance with a determination that a second set of one or more criteria is satisfied, wherein the second set of one or more criteria includes a criterion that is satisfied when the authentication credential has been previously received by the first device, forgoing sending, to the second device via the communication channel of the first type, the set of one or more keys.

In some embodiments, a non-transitory computer-readable storage medium storing one or more programs configured to be executed by one or more processors of a first device is described. In some embodiments, the one or more programs includes instructions for: receiving, from a second device different from the first device via a first communication channel, an authentication credential; in response to receiving the authentication credential: in accordance with a determination that a first set of one or more criteria is satisfied, wherein the first set of one or more criteria includes a criterion that is satisfied when the authentication credential has not been previously received by the first device, sending, to the second device via the first communication channel, a set of one or more keys, wherein a key of the set of one or more keys corresponds to a second communication channel not currently established; and in accordance with a determination that a second set of one or more criteria is satisfied, wherein the second set of one or more criteria includes a criterion that is satisfied when the authentication credential has been previously received by the first device, forgoing sending, to the second device via the communication channel of the first type, the set of one or more keys.

In some embodiments, a transitory computer-readable storage medium storing one or more programs configured to be executed by one or more processors of a first device is described. In some embodiments, the one or more programs includes instructions for: receiving, from a second device different from the first device via a first communication channel, an authentication credential; in response to receiving the authentication credential: in accordance with a determination that a first set of one or more criteria is satisfied, wherein the first set of one or more criteria includes a criterion that is satisfied when the authentication credential has not been previously received by the first device, sending, to the second device via the first communication channel, a set of one or more keys, wherein a key of the set of one or more keys corresponds to a second communication channel not currently established; and in accordance with a determination that a second set of one or more criteria is satisfied, wherein the second set of one or more criteria includes a criterion that is satisfied when the authentication credential has been previously received by the first device, forgoing sending, to the second device via the communication channel of the first type, the set of one or more keys.

In some embodiments, a first device is described. In some embodiments, the first device comprises one or more processors and memory storing one or more programs configured to be executed by the one or more processors. In some embodiments, the one or more programs includes instructions for: receiving, from a second device different from the first device via a first communication channel, an authentication credential; in response to receiving the authentication credential: in accordance with a determination that a first set of one or more criteria is satisfied, wherein the first set of one or more criteria includes a criterion that is satisfied when the authentication credential has not been previously received by the first device, sending, to the second device via the first communication channel, a set of one or more keys, wherein a key of the set of one or more keys corresponds to a second communication channel not currently established; and in accordance with a determination that a second set of one or more criteria is satisfied, wherein the second set of one or more criteria includes a criterion that is satisfied when the authentication credential has been previously received by the first device, forgoing sending, to the second device via the communication channel of the first type, the set of one or more keys.

In some embodiments, a first device is described. In some embodiments, the first device comprises means for performing each of the following steps: receiving, from a second device different from the first device via a first communication channel, an authentication credential; in response to receiving the authentication credential: in accordance with a determination that a first set of one or more criteria is satisfied, wherein the first set of one or more criteria includes a criterion that is satisfied when the authentication credential has not been previously received by the first device, sending, to the second device via the first communication channel, a set of one or more keys, wherein a key of the set of one or more keys corresponds to a second communication channel not currently established; and in accordance with a determination that a second set of one or more criteria is satisfied, wherein the second set of one or more criteria includes a criterion that is satisfied when the authentication credential has been previously received by the first device, forgoing sending, to the second device via the communication channel of the first type, the set of one or more keys.

In some embodiments, a computer program product is described. In some embodiments, the computer program product comprises one or more programs configured to be executed by one or more processors of a first device. In some embodiments, the one or more programs include instructions for: receiving, from a second device different from the first device via a first communication channel, an authentication credential; in response to receiving the authentication credential: in accordance with a determination that a first set of one or more criteria is satisfied, wherein the first set of one or more criteria includes a criterion that is satisfied when the authentication credential has not been previously received by the first device, sending, to the second device via the first communication channel, a set of one or more keys, wherein a key of the set of one or more keys corresponds to a second communication channel not currently established; and in accordance with a determination that a second set of one or more criteria is satisfied, wherein the second set of one or more criteria includes a criterion that is satisfied when the authentication credential has been previously received by the first device, forgoing sending, to the second device via the communication channel of the first type, the set of one or more keys.

In some embodiments, a method that is performed at a first device is described. In some embodiments, the method comprises: connecting, via a first communication channel, to a second device different from the first device; and while connected to the second device via the first communication channel and after receiving an authentication response from the second device: in accordance with a determination that a first set of one or more criteria is satisfied, wherein the first set of one or more criteria includes a criterion that is satisfied when the second device corresponds to a known device, sending, to the second device, a subsequent communication; and in accordance with a determination that a second set of one or more criteria is satisfied, wherein the second set of one or more criteria includes a criterion that is satisfied when the second device corresponds to an unknown device, delaying sending, to the second device, the subsequent communication.

In some embodiments, a non-transitory computer-readable storage medium storing one or more programs configured to be executed by one or more processors of a first device is described. In some embodiments, the one or more programs includes instructions for: connecting, via a first communication channel, to a second device different from the first device; and while connected to the second device via the first communication channel and after receiving an authentication response from the second device: in accordance with a determination that a first set of one or more criteria is satisfied, wherein the first set of one or more criteria includes a criterion that is satisfied when the second device corresponds to a known device, sending, to the second device, a subsequent communication; and in accordance with a determination that a second set of one or more criteria is satisfied, wherein the second set of one or more criteria includes a criterion that is satisfied when the second device corresponds to an unknown device, delaying sending, to the second device, the subsequent communication.

In some embodiments, a transitory computer-readable storage medium storing one or more programs configured to be executed by one or more processors of a first device is described. In some embodiments, the one or more programs includes instructions for: connecting, via a first communication channel, to a second device different from the first device; and while connected to the second device via the first communication channel and after receiving an authentication response from the second device: in accordance with a determination that a first set of one or more criteria is satisfied, wherein the first set of one or more criteria includes a criterion that is satisfied when the second device corresponds to a known device, sending, to the second device, a subsequent communication; and in accordance with a determination that a second set of one or more criteria is satisfied, wherein the second set of one or more criteria includes a criterion that is satisfied when the second device corresponds to an unknown device, delaying sending, to the second device, the subsequent communication.

In some embodiments, a first device is described. In some embodiments, the first device comprises one or more processors and memory storing one or more programs configured to be executed by the one or more processors. In some embodiments, the one or more programs includes instructions for: connecting, via a first communication channel, to a second device different from the first device; and while connected to the second device via the first communication channel and after receiving an authentication response from the second device: in accordance with a determination that a first set of one or more criteria is satisfied, wherein the first set of one or more criteria includes a criterion that is satisfied when the second device corresponds to a known device, sending, to the second device, a subsequent communication; and in accordance with a determination that a second set of one or more criteria is satisfied, wherein the second set of one or more criteria includes a criterion that is satisfied when the second device corresponds to an unknown device, delaying sending, to the second device, the subsequent communication.

In some embodiments, a first device is described. In some embodiments, the first device comprises means for performing each of the following steps: connecting, via a first communication channel, to a second device different from the first device; and while connected to the second device via the first communication channel and after receiving an authentication response from the second device: in accordance with a determination that a first set of one or more criteria is satisfied, wherein the first set of one or more criteria includes a criterion that is satisfied when the second device corresponds to a known device, sending, to the second device, a subsequent communication; and in accordance with a determination that a second set of one or more criteria is satisfied, wherein the second set of one or more criteria includes a criterion that is satisfied when the second device corresponds to an unknown device, delaying sending, to the second device, the subsequent communication.

In some embodiments, a computer program product is described. In some embodiments, the computer program product comprises one or more programs configured to be executed by one or more processors of a first device. In some embodiments, the one or more programs include instructions for: connecting, via a first communication channel, to a second device different from the first device; and while connected to the second device via the first communication channel and after receiving an authentication response from the second device: in accordance with a determination that a first set of one or more criteria is satisfied, wherein the first set of one or more criteria includes a criterion that is satisfied when the second device corresponds to a known device, sending, to the second device, a subsequent communication; and in accordance with a determination that a second set of one or more criteria is satisfied, wherein the second set of one or more criteria includes a criterion that is satisfied when the second device corresponds to an unknown device, delaying sending, to the second device, the subsequent communication.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a compute system in accordance with some embodiments.

FIG. 2 is a block diagram illustrating a device with interconnected subsystems in accordance with some embodiments.

FIG. 3 is a swim-lane diagram illustrating a process for communicating data in accordance with some embodiments.

FIGS. 4A-4C are exemplary user interfaces that are displayed in accordance with some embodiments.

FIG. 5 is a flow diagram illustrating a method for sending communication information in accordance with some embodiments.

FIG. 6 is a flow diagram illustrating a method for selectively sending keys in accordance with some embodiments.

FIG. 7 is a swim-lane diagram illustrating a process for delaying communication in accordance with some embodiments.

FIG. 8 is a flow diagram illustrating a method for selectively delaying communication in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

Methods and/or processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

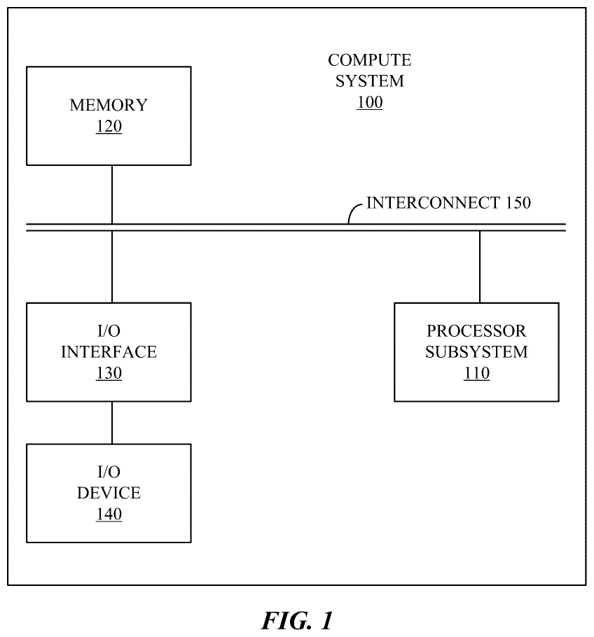

Turning to FIG. 1, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such embodiments, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such embodiments, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such embodiments, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

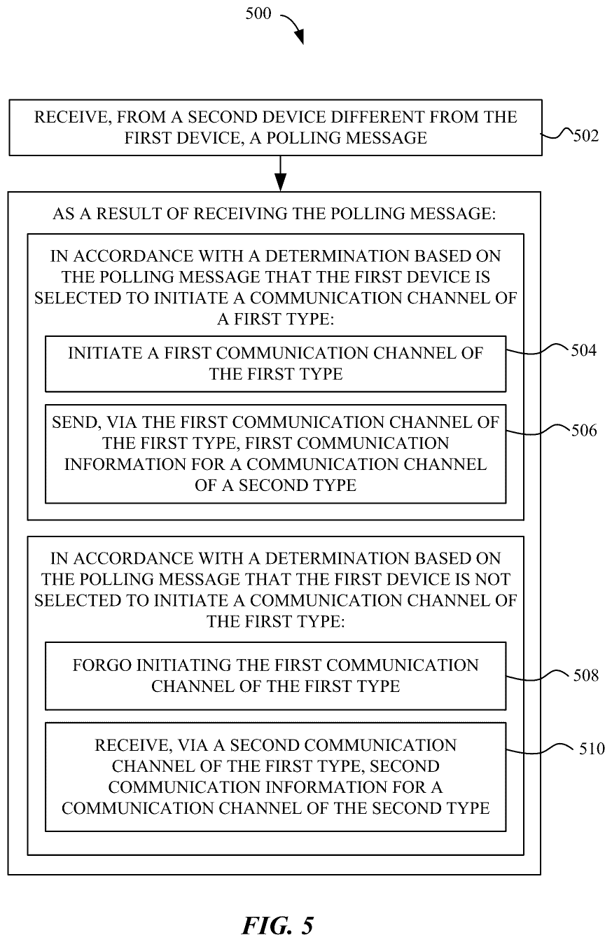

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with methods 500, 600, and 800 (FIGS. 5, 6, and 8) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly wired to the network.

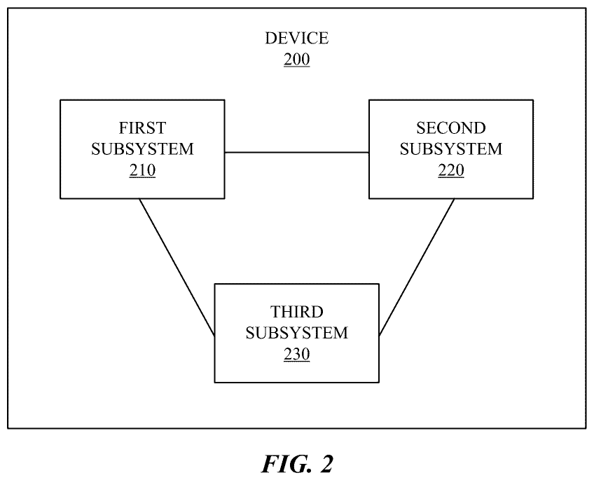

FIG. 2 illustrates a block diagram of device 200 with interconnected subsystems in accordance with some embodiments. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1 (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such embodiments, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

As used herein, an “installed application” refers to a software application that has been downloaded onto a computer system (e.g., compute system 100 and/or device 200) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of a system/global internal state and/or an application internal state). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards techniques for communicating data. Such techniques are described in the context of two smartphones communicating contact information and then a photo. It should be recognized that other types of devices and other data can be used with techniques described herein. For example, a head-mounted display (HMD) device can be worn by a user that shows a name of another user as the other user approaches. In addition, techniques optionally complement or replace other techniques for communicating data.

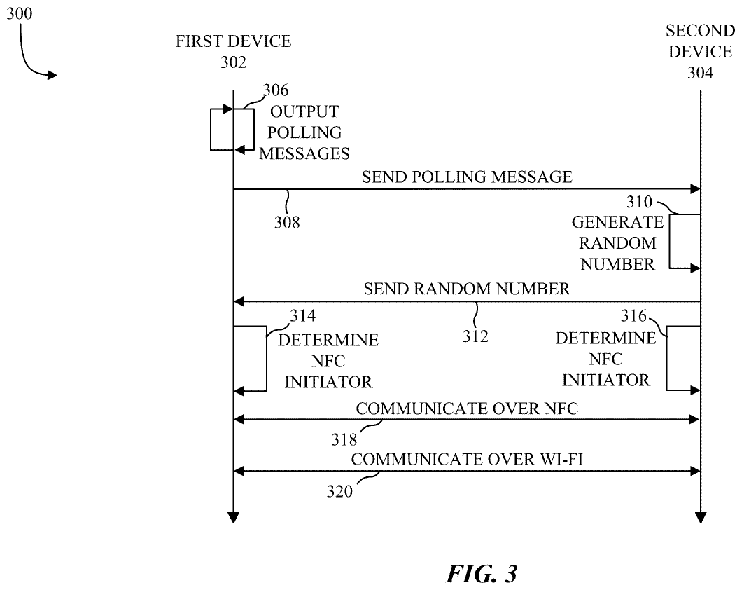

FIG. 3 is a swim-lane diagram illustrating a process (e.g., process 300) for communicating data in accordance with some embodiments. As illustrated in FIG. 3, process 300 includes first device 302 and second device 304. In some embodiments, first device 302 and/or second device 304 include one or more components described above with respect to device 200 and/or compute system 100.

In some embodiments, first device 302 is a smartphone including one or more different components for communicating with another device. For example, first device 302 can include an NFC reader and/or an NFC tag for communicating over NFC. In some embodiments, first device 302 can include one or more radio antennas for wirelessly communicating over one or more different protocols (e.g., Wi-Fi and/or Bluetooth). In some embodiments, second device 304 is also a smartphone including the same or different components as first device 302. It should be recognized that first device 302 and/or second device 304 can be other types of devices, such as a smart watch or an HMD device.

At 306, first device 302 outputs polling messages. For example, as part of communicating via NFC, first device 302 can output one or more polling messages to identify nearby NFC tags. In some embodiments, the polling messages are output via an NFC component and performed at some frequency. In some embodiments, the NFC component is in a lower power mode and outputting polling messages at a slower rate than when in a higher power mode so as to reduce the effect on power and/or performance of outputting the polling messages. In such embodiments, first device 302 can always be in the lower power mode and/or be in the lower power mode irrespective of detecting another device and/or user. In some embodiments, second device 304 also outputs polling messages via an NFC component of second device 304. In other embodiments, second device 304 does not output polling messages. In some embodiments, first device 302 outputs polling messages in response to a determination to initiate a communication session (e.g., an NFC communication, a Wi-Fi communication, and/or a Bluetooth communication) with second device 304. For example, first device 302 can output polling messages in response to detecting an input corresponding to a user-interface element to share content, an input corresponding to a user interface including shareable content (e.g., a contact card of a contact stored by first device 302), an input corresponding to a digital wallet (e.g., an input to display a user interface of the digital wallet and/or a pass of the digital wallet), an input corresponding to a user interface with account information (e.g., an input to display account information of an application and/or information of one or more games), and/or an event or signal that indicates that a user of first device 302 wants to initiate the communication session (e.g., a signal inferred from user action, such as displaying a particular user interface for sharing data and/or that includes data able to be shared between devices and/or being brought within proximity of second device 304). In some embodiments, first device 302 outputs polling messages before a determination to initiate a communication session (e.g., an NFC communication, a Wi-Fi communication, and/or a Bluetooth communication) with second device 304. For example, first display 302 can output polling messages continuously at one or more rates and/or in response to displaying a particular user interface but not determine to initiate an NFC communication with second device 304 (e.g., as described below with respect to 314) until an input corresponding to a particular user interface element is detected. It should be recognized that other inputs and/or signals can cause polling messages to be sent and/or first device 302 to determine to initiate a communication session with second device 304.

At 308, first device 302 sends a polling message to second device 304. Notably, the polling message being sent to second device 304 is indicative of second device 304 being within range of an NFC component of first device 302 (e.g., first device 302 is sending other polling messages but the other polling messages are not sent to second device 302 because second device 302 is not within range). In some embodiments, the polling message includes a random number generated by first device 302 (referred to herein as the random number of first device 302).

At 310, second device 304 generates a random number (referred to herein as the random number of second device 304). In some embodiments, the random number of second device 304 is generated in response to receiving the polling message at 308. In some embodiments, the random number of second device 304 is generated before receiving the polling message, such as part of second device 304 outputting polling messages.

At 312, second device 304 sends the random number of second device 304 to first device 302. In some embodiments, the random number of second device 304 is sent after and/or in response to receiving the polling message at 308. In other embodiments, the random number of second device 304 is sent in a polling message sent from second device 304 to first device 302 (e.g., as part of second device 302 outputting polling messages).

At 314, first device 302 determines whether to initiate an NFC communication with second device 304 (e.g., take on the role of NFC reader and/or NFC initiator). In some embodiments, the determination is based on whether the random number of first device 302 is less than the random number of second device 304. For example, first device 302 can determine to initiate the NFC communication (e.g., determine to take on the role of NFC reader) in response to determining that the random number of first device 302 is less than the random number of second device 304. In such an example, first device 302 can determine to not initiate the NFC communication (e.g., determine to take on the role of NFC tag) in response to determining that the random number of first device 302 is greater than the random number of second device 304. It should be recognized that, in some embodiments, one or more of the criteria described above with respect to 306 can be used in addition to and/or instead of determining that the random number of first device 302 is less than the random number of second device 304.

At 316, second device 304 determines whether to initiate an NFC communication with first device 304 (e.g., determine to take on the role of NFC reader and/or NFC initiator). In some embodiments, the determination is based on whether the random number of second device 304 is less than the random number of first device 302. For example, second device 304 can determine to initiate the NFC communication (e.g., determine to take on the role of NFC reader) in response to determining that the random number of second device 304 is less than the random number of first device 302. In such an example, second device 304 can determine to not initiate the NFC communication (e.g., take on the role of NFC tag) in response to determining that the random number of second device 304 is greater than the random number of first device 302. In some embodiments, first device 302 and second device 304 can each determine whether to initiate an NFC communication using the same two random numbers. Notably, the use of numbers sent and received allows the devices to independently determine whether to initiate an NFC communication and, in some embodiments, only one of the devices to initiate at a time.

At 318, first device 302 and second device 304 communicate over NFC. If first device 302 determines to initiate the NFC communication, first device 302 initiates the NFC communication (e.g., reads data from an NFC tag of second device 304). If second device 304 determines to initiate the NFC communication, second device 304 initiates the NFC communication (e.g., reads data from an NFC tag of first device 302). In some embodiments, the device not initiating the communication acts as an NFC tag for the NFC communication. For example, the device not initiating the communication can make information available to be sent over NFC. It should be recognized that NFC is just one example of a type of communication channel that can be used and, in other embodiments, other types of communication channels can be used.

In some embodiments, the information sent via NFC includes data for establishing, initiating, connecting, and/or communicating over a different communication channel (e.g., Bluetooth or Wi-Fi). For example, the information can include an identification of a type of communication channel (e.g., Bluetooth or Wi-Fi), an identification of a network to be used for the different communication channel, and/or any information needed to establish, initiate, connect with, and/or communicate to the different communication channel.

In some embodiments, the information sent via NFC includes an authentication credential that is used by the other device to determine whether the other device knows of the device. In some embodiments, the authentication credential is private such that the other device determines whether the other device knows of the device by comparing the authentication credential to other authentication credentials stored by the other device. Such other authentication credentials can be previously received by the other device. When there is a match between authentication credentials, the other device can determine that they know the device and initiate a process corresponding to known devices (e.g., displaying different content, establishing different types of communication channels, and/or sending/requesting different types of information from the device). In some embodiments, after matching credentials and before initiating a process corresponding to known devices, the other device can validate the authentication credential using a public key stored and/or received with authentication credentials previously received. When the authentication credential is not validated, the other device can treat the device as unknown. When there is not a match between authentication credentials, the other device can determine that they do not know the device and initiate a process corresponding to new devices (e.g., displaying different content, establishing different types of communication channels, and/or sending/requesting different types of information from the device). The process corresponding to new devices can include communicating (e.g., via NFC or via the other communication channel) one or more keys (e.g., long-term keys) to be used by the other device for subsequent communications (e.g., the communication at 320 or a communication after the communication at 320).

In some embodiments, the information sent via NFC includes device capabilities and/or context of the device. For example, the information can indicate whether the device includes a particular type of output component (e.g., an external monitor, an external keyboard, headphones, a speaker, and/or a projector) and/or is in communication with another device (e.g., a HMD device). Such information can be included in the authentication credential described above or be separate.

At 320, first device 302 and second device 304 communicate over Wi-Fi. In some embodiments, first device 302 and second device 304 communicate over Wi-Fi using information exchanged at 318. In some embodiments, first device 302 and second device 304 communicate data selected, stored, and/or configured at each and/or either device. For example, first device 302 can detect an input corresponding to a request to send contact information (e.g., stored by first device 302) to second device 304 and, in response, send the contact information and/or one or more fields (e.g., a name, a number, and/or an address of a contact) of the contact information (e.g., less than all of the fields of the contact information) over Wi-Fi to second device 304 at 320. For another example, first device 302 can send other data corresponding to, associated with, and/or accessible by first device 302, including an image, a video, a webpage, a URL, a widget, a document (e.g., a text-based and/or spreadsheet document), data from an application (e.g., executing at least partially on first device 302, such as account and/or game center information (e.g., account statistics and/or game scores)), a pass of a digital wallet, one or more fields of a pass of a digital wallet (e.g., a credit card number, a coupon, an event pass, a name, a birthdate, a car key, a home key, and/or a credential), and/or information needed to establish an application session between the two devices (e.g., a collaboration session (e.g., a synchronous communication session such as a video call or an asynchronous collaboration session such as a document share)). Notably, by switching from NFC to Wi-Fi, the devices no longer need to be as close to each other. It should be recognized that Wi-Fi is just one example of a type of communication channel that can be used and, in other embodiments, other types of communication channels can be used. In some embodiments, first device 302 initiates communication over Wi-Fi (and/or another type of communication channel) in response to a determination that one or more of the criteria described above with respect to 306 is satisfied. For example, first device 302 can prepare to (e.g., by performing one or more of the steps described above with respect to 308, 314, and/or 318) initiate communication over Wi-Fi before the determination that one or more of the criteria described above is satisfied (e.g., but not initiate the communication over Wi-Fi).

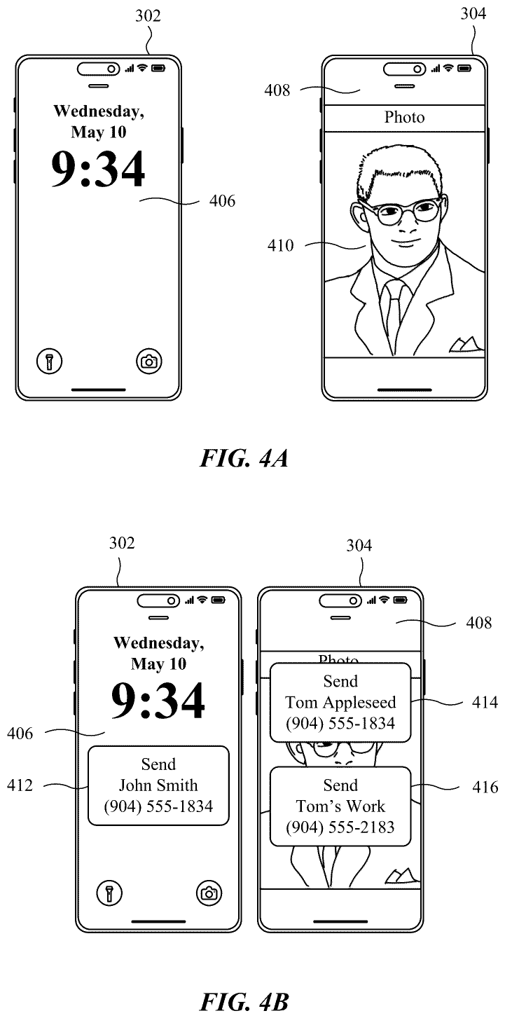

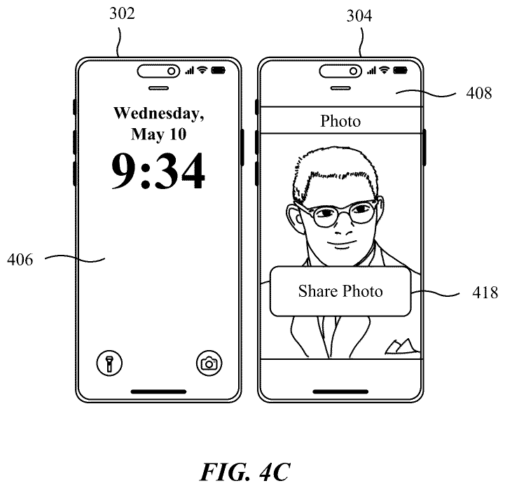

FIG. 4A-4C are exemplary user interfaces that are displayed in accordance with some embodiments. The user interfaces in these figures are used to illustrate the processes described above and below, including the processes in FIGS. 3 and 5-6.

As illustrated, FIGS. 4A-4C are in the context of a first smartphone (e.g., first device 302) approaching a second smartphone (e.g., second device 304) and exchanging data. At FIG. 4A, first device 302 (e.g., a smartphone) is out of range of second device 304. While out of range, the two devices are not communicating with each other and instead are operating independently of each other.

As illustrated in FIG. 4A, first device 302 displays lock screen 406. In some embodiments lock screen 406 is displayed when first device 302 is in a locked state and/or not being used. In such embodiments, a user can have access to limited functionality while first device 302 is in the locked state, requiring the user to dismiss lock screen 406 to gain access to further functionality. As also illustrated in FIG. 4A, second device 304 displays photo user interface 408 with photo 410. In some embodiments, photo user interface 408 is displayed by second device 304 while in an unlocked state. In such embodiments, a user of second device 304 can be actively using second device 304 while photo user interface 408 is displayed. It should be recognized that lock screen 406 and photo user interface 408 are merely embodiments of what devices can be displaying and that the devices can display other user interfaces and/or not be displaying a user interface.

In the context of FIG. 4A, first device 302 and/or second device 304 can be outputting polling messages to attempt to communicate with other devices (e.g., as described above with respect to 306). In some embodiments, such polling messages can be output via NFC, such as while an NFC component is in a lower power mode.

In some embodiments, a user of first device 302 initiates communication over NFC through a control while and/or before outputting polling messages to attempt to communicate with other devices. In some embodiments, such control is associated with (e.g., corresponds to and/or is displayed within) an application. For example, a user interface element on a document application, a digital wallet application, a media application (e.g., photo sharing application, photo viewing and/or video playback application, and/or video streaming application), and/or a game application (e.g., installed game, game center, and/or game center enabled application). In some embodiments, such control corresponds to a device functionality. For example, a user interface element to share contact information (e.g., a contact field (e.g., phone number, address, and/or any one or more additional fields) and/or contact photo), device information (e.g., identification of connected Wi-Fi network, identification of connected Bluetooth device, and/or connected storage mediums), and/or network information (e.g., identification and/or password for a Wi-Fi network, identification of another connected shareable device (e.g., speaker, smart watch, head-mounted-display (HMD) device, and/or laptop)). In some embodiments, such control is associated with an event or signal that indicates that the user intends to initiate communication over NFC (e.g., a signal inferred from user input and/or event caused by an application). In some embodiments, first device 302 and/or second device 304 suppress (e.g., complete associated functionality without displaying user interfaces and/or controls associated with the functionality) displaying of the controls (e.g., control 412, first control 414 and/or second control 416) as illustrated below at FIG. 4B. For example, first device 302 suppressing control 412 when a user selects a control within a contract card to send one or more fields of the contact information over NFC.

At FIG. 4B, first device 302 has been brought in proximity to second device 304. For example, a user of first device 302 has brought first device 302 near second device 304. In some embodiments, in response to proximity (e.g., such as being within range of receiving a polling message) and while first device and/or second device 304 continue to output polling messages, first device 302 receives a polling message from second device 304 (e.g., as described above with respect to 306). In response to receiving the polling message, first device 302 determines based on the polling message whether to initiate an NFC communication (e.g., as described above with respect to 314) and, if so, initiates the NFC communication. While communicating over NFC (e.g., as described above with respect to 318), first device 302 and/or second device 304 sends information to establish another communication channel (e.g., Bluetooth or Wi-Fi). Based on such information, the other communication channel is established (e.g., as described above with respect to 320), and first device 302 and second device 304 are able to communicate via the other communication channel.

As illustrated in FIG. 4B, first device 302 displays control 412 on top of lock screen 406. In some embodiments, control 412 is displayed after receiving the polling message, in response to receiving the polling message, after communicating via NFC, while communicating via NFC, and/or while communicating via the other communication channel. In some embodiments, control 412 corresponds to and/or includes data stored and/or configured to be shared by first device 302 (e.g., data from an application (e.g., media application (e.g., photo, video, sharing, and/or streaming application), document application (e.g., presentation and/or spreadsheet application), and/or game application (e.g., game center enabled and/or not game centered enabled)), one or more fields of a contact card, data from one or more cards and/or passes within a digital wallet application, and/or connection information (e.g., network information, session information, and/or collaboration session information)). In some embodiments, first device 302 detecting input directed to control 412 causes the information to be sent to second device 304 over the other communication channel.

As also illustrated in FIG. 4B, second device 304 displays first control 414 and second control 416 on top of photo user interface 408. In some embodiments, first control 414 and/or second control 416 corresponds to and/or includes data stored and/or configured to be shared by second device 304 (e.g., an application, a widget, one or more fields of a contact card, data from one or more cards and/or passes within a digital wallet application, and/or connection information (e.g., network information, session information, and/or collaboration session information)). In some embodiments, the data corresponding to first control 414 and/or second control 416 is the same type and/or different type of data as corresponding to control 412. In some embodiments, second device 304 detecting input directed to first control 414 causes data corresponding to first control 414 to be sent to first device 302 over the other communication channel. In some embodiments, second device 304 detecting input directed to second control 416 causes data corresponding to second control 416 to be sent to first device 302 over the other communication channel. It should be recognized that such data is used as merely an example and other data can be displayed and/or sent between the devices.

After FIG. 4B, first device 302 and second device 304 can stop communicating with each other (e.g., disconnect and/or terminate one or more communication channels). For example, first device 302 and second device 304 can be taken out of proximity. After stopping communication, first device 302 can be brought back into proximity of second device 304 while again outputting polling messages as described above. In response to being brought back into proximity, first device 302 can send a polling message (e.g., with a new random number) to second device 304. Similar as described above, second device 304 can generate a new random number and send the new random number to first device 304. Based on these new random numbers, first device 302 and second device 304 can determine which device to initiate an NFC communication and communicate accordingly.

As mentioned above, the NFC communication between first device 302 and second device 304 can include an authentication credential to be used to determine whether the devices have previously communicated. In some embodiments, as a result of the devices previously communicating (e.g., in FIG. 4B), first device 302 and/or second device 304 can determine to communicate differently than described with respect to FIG. 4B. For example, one or more keys (e.g., the long-term keys described above) might not be communicated between the devices. For another example, first device 302 and second device 304 can communicate via Bluetooth with respect to FIG. 4B (when the devices do not know each other) and can communicate via Wi-Fi with respect to FIG. 4C (when the device known each other) or vice versa. In some embodiments, as a result of the devices previously communicating (e.g., in FIG. 4B), first device 302 and/or second device 304 can determine to display different information than described with respect to FIG. 4B. For example, first device 302 and second device 304 can display controls for sending contact information with respect to FIG. 4B (when the devices do not know each other) and can choose not to display any controls (e.g., as illustrated by first device 302 in FIG. 4C) or display different controls (e.g., as illustrated by second device 304 in FIG. 4C).

As illustrated in FIG. 4C, second device 304 displays control 418 on top of photo user interface 408. In some embodiments, control 418 includes an indication of information stored and/or configured to be shared by second device 402. For example, as a result of second device 304 currently viewing a photo, second device 304 can display a control to send the photo in response to and/or after connecting with first device 304 using the techniques described herein. In some embodiments, second device 304 detecting input directed to control 418 causes the photo to be sent to first device 302 over the other communication channel.

While the above described some use cases, it should be recognized that disclosure here can be used in other use cases. For example, when two users approach each other wearing augmented reality devices, subject matter described herein can cause one or both of the augmented reality devices to display information about the other person. In some embodiments, the augmented reality devices can include NFC components and the NFC communication can be between the NFC components. In other embodiments, a smart phone connected to an augmented reality device can be used. In such example, an NFC component of the smart phone can be used to retrieve content to be displayed by the augmented reality device.

FIG. 5 is a flow diagram illustrating a method (e.g., method 500) for sending communication information in accordance with some embodiments. Some operations in method 500 are, optionally, combined, the orders of some operations are, optionally, changed, and some operations are, optionally, omitted.

As described below, method 500 provides an intuitive way for sending communication information. Method 500 reduces the cognitive burden on a user, thereby creating a more efficient human-machine interface. For battery-operated computing devices, enabling a user to interact with such devices faster and more efficiently conserves power and increases the time between battery charges.

In some embodiments, method 500 is performed at a first device (e.g., a user device and/or a personal device). In some embodiments, the first device is a smart phone, a smart watch, a wearable device, a head-mounted-display (HMD) device, a laptop, a tablet, and/or a desktop computer.

At 502, the first device receives (e.g., via a data channel, a data pipe, a near-field-communication (NFC) channel, and/or an NFC data pipe), from a second device (e.g., a user device and/or a personal device) different from the first device, a polling message (e.g., data, a signal, a packet, a frame, and/or an enhanced contactless polling (ECP) frame). In some embodiments, the polling message includes a request for particular information. In some embodiments, the second device is a smart phone, a smart watch, a wearable device, a head-mounted-display (HMD) device, a laptop, a tablet, and/or a desktop computer.

At 504, as a result of (e.g., after and/or in response to) receiving the polling message, in accordance with a determination based on the polling message that the first device is selected to initiate (and/or as an initiator of) a communication channel of a first type (e.g., a data channel, a data pipe, a near-field-communication (NFC) channel, and/or an NFC data pipe) (e.g., establish the communication channel of the first type and/or establish a two-way communication channel), the first device initiates a first communication channel of the first type. In some embodiments, in response to comparing the random number to another random number included in the polling message and in accordance with a determination that the random number is less than (or, in some embodiments, greater than) the other random number included in the polling message, the first device initiates the first communication channel of the first type. In some embodiments, in response to receiving the polling message, the first device negotiates with the second device to determine which device is to initiate a communication channel of the first type. In some embodiments, in response to receiving the polling message, the first device generates and sends a random number to the second device. In some embodiments, in response to receiving the polling message, the first device generates a random number and compares the random number to another random number included in the polling message.

At 506, as a result of receiving the polling message and in accordance with the determination based on the polling message that the first device is selected to initiate the communication channel of the first type, the first device sends, via the first communication channel of the first type, first communication information for a communication channel of a second type (e.g., a data channel, a data pipe, a wireless connection, such as via Wi-Fi and/or Bluetooth). In some embodiments, the first communication information includes information to assist in establishing a communication channel of the second type.

At 508, as a result of receiving the polling message and in accordance with a determination based on the polling message that the first device is not selected to initiate a communication channel of the first type, the first device forgoes initiating the first communication channel of the first type. In some embodiments, in response to comparing the random number to another random number included in the polling message and in accordance with a determination that the random number is greater than (or, in some embodiments, less than) the other random number included in the polling message, the first device waits and/or allows for the second device to initiate a communication channel of the first type. In some embodiments, as a result of receiving the polling message and in accordance with a determination that the first device is not to initiate a communication channel of the first type based on the polling message, the first device transitions into a mode for receiving a request to initiate a communication channel of the first type (e.g., activates an NFC tag and/or card and/or transitions into a mode corresponding to an NFC tag and/or card).

At 510, as a result of receiving the polling message and in accordance with the determination based on the polling message that the first device is not selected to initiate the communication channel of the first type, the first device receives, via a second communication channel of the first type, second communication information for a communication channel of the second type (e.g., without receiving the first communication information). In some embodiments, the second device initiates the second communication channel of the first type (e.g., in accordance with a determination that the second device is to initiate a communication channel of the first type). In some embodiments, the second communication information includes information to assist in establishing a communication channel of the second type. In some embodiments, when the first communication information is sent, the second communication is not received. In some embodiments, when the second communication information is received, the first communication information is not sent.

In some embodiments, after receiving the polling message, the first device communicates, via a first communication channel of the second type, with the second device, wherein the first communication channel of the second type is established based on the first communication information or the second communication information. In some embodiments, after sending the first communication information for a communication channel of the second type, the first device establishes, based on the first communication information, the first communication channel. In some embodiments, after receiving the second communication information for a communication channel of the second type, the first device establishes, based on the second communication information, the first communication channel. In some embodiments, after receiving the first communication information for a communication channel of the second type, the second device establishes, based on the first communication information, the first communication channel of the second type. In some embodiments, after sending the second communication information for a communication channel of the second type, the second device establishes, based on the second communication information, the first communication channel of the second type. In some embodiments, the first communication channel of the second type is established, by the first device or the second device, based on the first communication information and/or the second communication information.

In some embodiments, after (and/or, in some embodiments, in conjunction with and/or in response to) a second communication channel of the second type is established between the first device and the second device, the first device detects, via one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, and/or a button) of (and/or in communication with) the first device, an input (e.g., a tap input, a swipe input, a rotation of a rotatable input mechanism, a voice command, a hand input (e.g., an air tap and/or an air swipe), and/or one or more non-tap inputs, such as an air input (e.g., a pointing air gesture, a tapping air gesture, a swiping air gesture, and/or a moving air gesture), a gaze input, a gaze-and-hold input, a mouse click, a mouse click-and-drag, a voice command, a selection input, and/or an input that moves the computer system in a particular direction) corresponding to a request to send first content (e.g., contact information, an image, a video, a document, an application, and/or a media item) via the second communication channel of the second type. In some embodiments, the second communication channel of the second type is the first communication channel of the second type. In some embodiments, the second communication channel of the second type is different from the first communication channel of the second type. In some embodiments, the second communication channel of the second type is established using different communication information than the first communication channel of the second type (e.g., the second communication channel of the second type uses the second communication information and the first communication channel of the second type uses the first communication information). In some embodiments, in response to detecting the input corresponding to the request to send the content via the second communication channel of the second type, the first device sends, to the second device via the second communication channel of the second type, the first content.

In some embodiments, after (and/or, in some embodiments, in conjunction with and/or in response to) the second communication channel of the second type is established between the first device and the second device and before sending the first content to the second device via the second communication channel of the second type, the first device receives, from the second device via the second communication channel of the second type, second content (e.g., contact information, an image, a video, a document, an application, and/or a media item). In some embodiments, the second content is different from the first content. In some embodiments, the second content is received by the first device before the first device sends content to the second device via the second communication channel of the second type.

In some embodiments, after (and/or, in some embodiments, in conjunction with and/or in response to) a third communication channel of the second type is established between the first device and the second device, the first device sends (e.g., shares, provides, and/or transmits), via the third communication channel of the second type, a key (e.g., identity resolving key (IRK) and/or a public key) for a communication channel of a third type (e.g., a data channel, a data pipe, a wireless connection, such as via Wi-Fi and/or Bluetooth) (e.g., a one-way communication channel) different from the first type. In some embodiments, a communication channel of the third type is separate from the third communication channel of the second type. In some embodiments, the third communication channel of the second type is the first communication channel of the second type or the second communication channel of the second type. In some embodiments, a communication channel of the third type is a communication channel of the second type. In some embodiments, a communication channel of the third type is different from a communication channel of the second type.

In some embodiments, the polling message is received via a near-field communication (NFC) component (e.g., in a low power card detection (LPCD) mode) (e.g., using a NFC protocol) of the first device. In some embodiments, a communication channel of the first type includes an NFC channel. In some embodiments, the first communication channel of the first type is an NFC channel. In some embodiments, the second communication channel of the first type is an NFC channel. In some embodiments, a communication channel of the second type includes a wireless communication channel (e.g., a short-range wireless communication channel, such as Wi-Fi or Bluetooth).

In some embodiments, a first respective communication information (e.g., the first communication information, the second communication information, and/or another communication information different from the first communication information and the second communication information) includes an indication of a communication channel of the second type. In some embodiments, in accordance with a determination that the first communication information corresponds to a communication channel of a third type (e.g., Bluetooth), a communication channel of the third type is established between the first device and the second device. In some embodiments, in accordance with a determination that the first communication information corresponds to a communication channel of a fourth type (e.g., Wi-Fi), a communication channel of the fourth type is established between the first device and the second device. In some embodiments, a communication channel of the fourth type is different from a communication channel of the third type.

In some embodiments, after receiving the polling message, the first device receives, from the second device, a second polling message, wherein a communication channel of a fifth type (e.g., Bluetooth) is established between the first device and the second device as a result of (e.g., in conjunction with, based on, and/or in response to) the polling message, wherein as a result of (e.g., after and/or in response to) receiving the second polling message, a communication channel of a sixth type (e.g., Wi-Fi) is established between the first device and the second device, and wherein a communication channel of the sixth type is different from a communication channel of the fifth type.

In some embodiments, a second respective communication information (e.g., the first communication information, the second communication information, and/or another communication information different from the first communication information and the second communication information) includes a first public key (e.g., the first communication information includes a public key corresponding to the first device (e.g., and not corresponding to the second device)) (e.g., the second communication information includes a public key corresponding to the second device (e.g., and not corresponding to the first device)).

In some embodiments, the second communication information includes a second public key corresponding to the second device. In some embodiments, the first device verifies, using the second public key, a communication received from the second device via a communication channel of the second type (e.g., the communication is signed and/or includes a signature and/or a certificate that is verified using the second public key). In some embodiments, the second public key is the first public key. In some embodiments, the second respective communication information is the second communication information.

In some embodiments, a respective communication information (e.g., the first communication information or the second communication information) includes a unique identifier (e.g., UUID) to identify an instance (e.g., a Wi-Fi and/or broadcast name of a network) of a communication channel of the second type.

In some embodiments, the second communication information includes a second public key corresponding to the second device. In some embodiments, the first device verifies, using the second public key, a communication received from the second device via a communication channel of the second type (e.g., the communication is signed and/or includes a signature and/or a certificate that is verified using the second public key). In some embodiments, the second public key is the first public key. In some embodiments, the second respective communication information is the second communication information.

In some embodiments, the determination based on the polling message includes: comparing a first random number included in the polling message with a second random number generated by the first device; and in response to comparing the first random number with the second random number: in accordance with a determination that the first random number satisfies a set of one or more criteria with respect to the second random number (e.g., that the first random number is less or greater than the second random number), determining that the first device is selected to initiate a communication channel of the first type (and/or that the second device is selected to not initiate a communication channel of the first type); and in accordance with a determination that the second random number satisfies the set of one or more criteria with respect to the first random number (e.g., that the second random number is less or greater than the second random number), determining that the first device is not selected to initiate a communication channel of the first type (and/or that the second device is selected to initiate a communication channel of the first type). In some embodiments, in response to receiving the polling message, the first device generates the second random number.

Note that details of the processes described above with respect to method 500 (e.g., FIG. 5) are also applicable in an analogous manner to other methods described herein. For example, method 600 optionally includes one or more of the characteristics of the various methods described above with reference to method 500. For example, the authentication information of method 600 can be included in communication information sent in method 500. For brevity, these details are not repeated below.

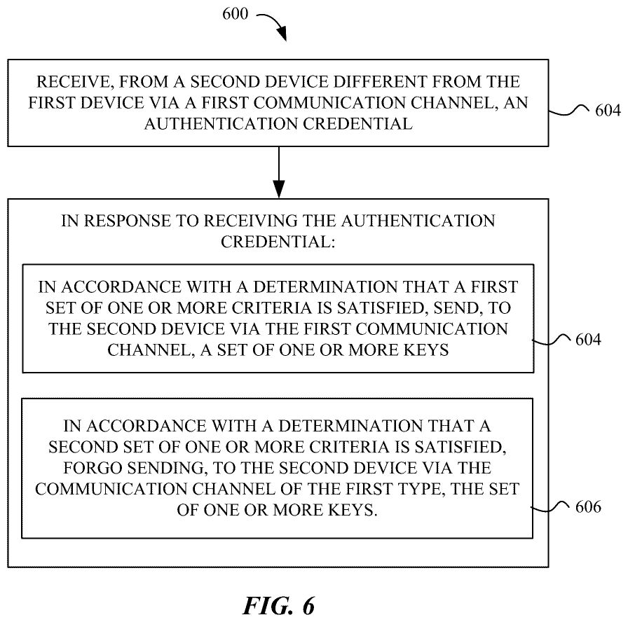

FIG. 6 is a flow diagram illustrating a method (e.g., method 600) for selectively sending keys in accordance with some embodiments. Some operations in method 600 are, optionally, combined, the orders of some operations are, optionally, changed, and some operations are, optionally, omitted.

As described below, method 600 provides an intuitive way for selectively sending keys. Method 600 reduces the cognitive burden on a user, thereby creating a more efficient human-machine interface. For battery-operated computing devices, enabling a user to interact with such devices faster and more efficiently conserves power and increases the time between battery charges.

In some embodiments, method 600 is performed at a first device (e.g., a user device and/or a personal device). In some embodiments, the first device is a smart phone, a smart watch, a wearable device, a head-mounted-display (HMD) device, a laptop, a tablet, and/or a desktop computer.

At 602, the first device receives, from a second device (e.g., a user device and/or a personal device) different from the first device via a first communication channel (e.g., a data channel, a data pipe, a wireless connection, such as via Wi-Fi and/or Bluetooth) (e.g., as described above with respect to a communication channel of the second type of method 500), an authentication credential (e.g., a certificate, a private credential, a cryptographic credential, data used to authenticate an identity (e.g., of the second device), and/or data indicative of an identity (e.g., of the second device and/or a user account of the second device)) (e.g., corresponding to and/or for the second device and/or a user account of the second device). In some embodiments, the second device is a smart phone, a smart watch, a wearable device, a head-mounted-display (HMD) device, a laptop, a tablet, and/or a desktop computer. In some embodiments, the first communication channel is not a long-term connection.

At 604, in response to receiving the authentication credential and in accordance with a determination that a first set of one or more criteria is satisfied, wherein the first set of one or more criteria includes a criterion that is satisfied when the authentication credential has not been previously received by the first device (e.g., and/or that the first device cannot decode the authentication credential and/or otherwise establish that the authentication credential is known by the first device (e.g., the first device lost and/or deleted another authentication credential received from the second device) (e.g., another authentication credential received from the second device has expired and/or become invalidated)), the first device sends, to the second device via the first communication channel, a set of one or more keys (e.g., a public key and/or an identity resolving key (IRK) (e.g., corresponding to the first device)), wherein a key of the set of one or more keys corresponds to (e.g., is used to access, establish, validate, and/or initiate) a second communication channel (e.g., a data channel, a data pipe, a wireless connection, such as via Wi-Fi and/or Bluetooth) (e.g., as described above with respect to a communication channel of the second type of method 500) not currently established. In some embodiments, the first communication channel is stopped in response to sending or receiving content via the first communication channel. In some embodiments, the first communication channel is stopped in response to and/or after sending the set of one or more keys via the first communication channel. In some embodiments, the second communication channel is not stopped in response to sending or receiving content via the second communication channel. In some embodiments, the set of one or more keys corresponds to the second communication channel. In some embodiments, the second communication channel is configured to be established one or more times (e.g., re-established multiple time). In some embodiments, the second communication channel is a long-term connection. In some embodiments, in response to receiving the authentication credential and in accordance with a determination that the first set of one or more criteria is satisfied, the first device initiates a first protocol that includes sending the set of one or more keys.

At 606, in response to receiving the authentication credential, in accordance with a determination that a second set of one or more criteria is satisfied, wherein the second set of one or more criteria includes a criterion that is satisfied when the authentication credential has been previously received by the first device, the first device forgoes sending, to the second device via the communication channel of the first type, the set of one or more keys. In some embodiments, in response to receiving the authentication credential and in accordance with a determination that the second set of one or more criteria is satisfied, the first device initiates a second protocol different from the first protocol. In some embodiments, the second protocol does not include sending the set of one or more keys. In some embodiments, the second protocol includes sharing content between the first device and the second device.

In some embodiments, a communication channel of the first type includes an NFC channel. In some embodiments, the first communication channel of the first type is an NFC channel. In some embodiments, the second communication channel of the first type is an NFC channel. In some embodiments, a communication channel of the second type includes a wireless communication channel (e.g., a short-range wireless communication channel, such as Wi-Fi or Bluetooth).

In some embodiments, the authentication credential is indicative of the second device (and, in some embodiments, not indicative of the first device). In some embodiments, a first key of the one or more keys is a public key (e.g., corresponding to the first device). In some embodiments, the public key corresponds to and/or used with respect to the second communication channel. In some embodiments, the public key is configured to (and/or to be used to) verify an identity of the first device (e.g., by the second device using the public key to decrypt a portion of (e.g., a signature and/or a certification included in) a communication received from the first device). In some embodiments, the public key is configured to (and/or to be used to) encrypt a communication to be sent to the first device.

In some embodiments, a second key of the one or more keys is an address (e.g., an identity resolving key (IRK)) (e.g., a private address) corresponding to the first device. In some embodiments, a third key of the one or more keys is a long-term key (e.g., LTK). In some embodiments, a fourth key of the one or more keys is a persistent key (e.g., that is stored on the first device and the second device and used to derive an encryption key each time the first device and/or the second device communicate (e.g., in a session)). In some embodiments, a fifth key of the one or more keys is a Connection Signature Resolving Key (CSRK).

In some embodiments, the authentication credential is signed with a private key (e.g., corresponding to the second device). In some embodiments, the determination that the first set of one or more criteria is satisfied includes a comparison of the authentication credential with one or more authentication credentials stored on the first device (e.g., and the criterion of the first set of one or more criteria is satisfied when the authentication credential does not match an authentication credential stored on the first device). In some embodiments, the determination that the second set of one or more criteria is satisfied includes a comparison of the authentication credential with one or more authentication credentials stored on the first device (e.g., and the criterion of the second set of one or more criteria is satisfied when the authentication credential matches an authentication credential stored on the first device).

In some embodiments, in response to receiving the authentication credential and in accordance with a determination that the second set of one or more criteria is satisfied, the first device verifies, via a public key stored on the first device, a signature of the authentication credential (e.g., by calculating a first hash of the authentication credential, decrypting the signature using the public key to generate a second hash, and verify the authentication credential when the first hash matches the second hash). In some embodiments, the public key is stored with, associated with, corresponds to, and/or included in a second authentication credential stored on the first device. In some embodiments, the second authentication credential was received by the first device before receiving the authentication credential.

In some embodiments, after sending, to the second device, the set of one or more keys in response to receiving the authentication credential, the first device receives, from the second device, a third authentication credential. In some embodiments, the third authentication credential is the same as the authentication credential. In some embodiments, in response to receiving the third authentication credential (e.g., and in accordance with a determination that the second set of one or more criteria is satisfied (e.g., as a result of the third authentication credential matching the authentication credential (e.g., which, in some embodiments, is stored on the first device after receiving the authentication credential))), the first device forgoes sending, to the second device, the set of one or more keys.

In some embodiments, after (e.g., in response to, at some time after, and/or in conjunction with) receiving the authentication credential (and/or before detecting, via one or more input devices of the first device, input corresponding to a user of the first device), in accordance with a determination that the first set of one or more criteria is satisfied, the first device displays, via a display generation component of the first device, a first user interface (e.g., a graphical user interface that, in some embodiments, includes one or more user interface elements). In some embodiments, after receiving the authentication credential, in accordance with a determination that the second set of one or more criteria is satisfied, the first device displays, via the display generation component of the first device, a second user interface (e.g., a graphical user interface that, in some embodiments, includes one or more user interface elements) different from the first user interface. In some embodiments, the second user interface includes a user interface element not included in the first user interface.

Note that details of the processes described above with respect to method 600 (e.g., FIG. 6) are also applicable in an analogous manner to other methods described herein. For example, method 500 optionally includes one or more of the characteristics of the various methods described above with reference to method 600. For example, the first communication channel of method 600 can be the first communication channel of the first type of method 500. For brevity, these details are not repeated herein.

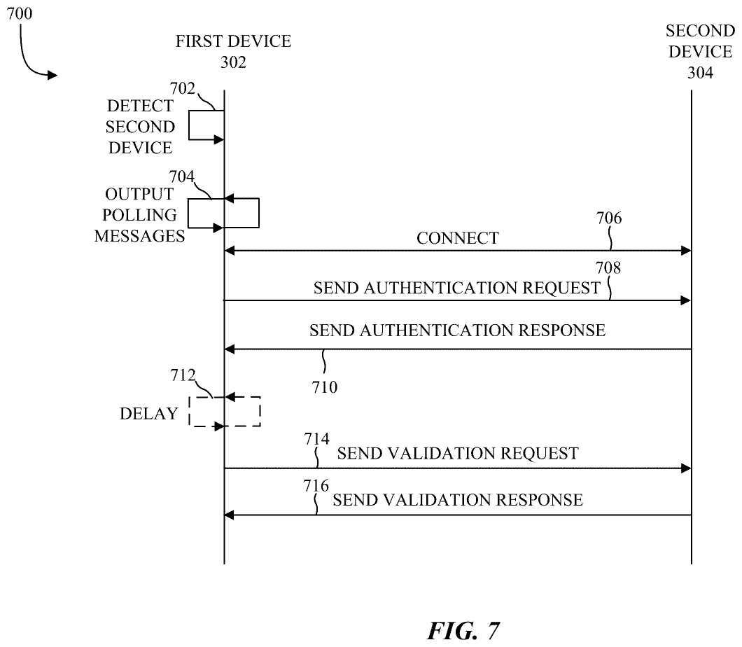

FIG. 7 is a swim-lane diagram illustrating a process (e.g., process 700) for selectively delaying communication in accordance with some embodiments. As illustrated in FIG. 7, process 700 includes first device 302 and second device 304. In some embodiments, first device 302 and/or second device 304 include one or more components described above with respect to device 200 and/or compute system 100.

At 702, first device 302 detects second device 304. For the purpose of this description, first device 302 and second device 304 are smartphones including one or more different components for communication with other devices (e.g., an NFC reader, NFC tag for communication over NFC, and/or one or more radio antennas for wirelessly communicating over one or more different protocols, such as Wi-Fi and/or Bluetooth). It should be recognized that first device 302 and/or second device 304 can be other types of devices, such as a smart watch and/or HMD device.

At 704, first device 302 outputs polling messages to establish a connection between first device 302 and second device 304. For example, first device 302 can output one or more polling messages to identify nearby NFC tags. In some embodiments, first device 302's NFC component is in a lower power mode while outputting the polling messages at 704. Notably, first device 302's NFC component operating in the lower power mode can allow for a reduced effect on power and/or performance of outputting the polling messages by requiring less power and/or processing bandwidth. In some embodiments, upon first device 302 detecting another device (e.g., second device 304), first device 302's NFC component transitions to a normal and/or higher power mode and outputs polling messages at a normal and/or higher rate (e.g., as compared to the lower power mode and/or as compared to a predefined output rate). In some embodiments, as discussed above, a device (e.g., first device 302 and/or second device 304) outputs polling messages (e.g., at one or more predefined rates) in response to detecting an input (e.g., an input corresponding to a user-interface element to share content and/or an input corresponding to a confirmation to share content). While discussed above with regards process 300, it should be understood that process 700 can include one or more steps from process 300 (e.g., sending polling messages, generating random numbers, and/or determining NFC initiators).

At 706, first device 302 and second device 304 establish a connection. In some embodiments, the connection between first device 302 and second device 304 is an NFC connection, allowing for NFC communication. For example, first device 302 initiating NFC communication by reading data from an NFC tag of second device 304. In some embodiments, communication between first device 302 and second device 304 does not include initiating NFC communication and includes making available information to be sent over NFC. For example, first device 302 readying information on an NFC tag for another device (e.g., second device 304) to read. It should be recognized that NFC is just one example of a type of communication channel that can be used and, in other embodiments, other types of communication channels can be used (e.g., Wi-Fi and/or Bluetooth).

At 708, while connected to second device 304, first device 302 sends an authentication request to second device 304. In some embodiments, the authentication request includes one or more pieces of identifying information corresponding to first device 302. For example, the authentication request can include a timestamp, a unique identifier, a public key, and/or an authentication tag. In some embodiments, the authentication tag is the authentication credential as described above in process 300. In some embodiments, the authentication request being sent by first device 302 is indicative of first device 302 establishing a connection with second device 304.

At 710, while connected to first device 302, second device 304 sends an authentication response. In some embodiments, the authentication response includes one or more pieces of identifying information corresponding to second device 304. For example, the authentication response can include a timestamp, a unique identifier, a public key, and/or an authentication tag. In some embodiments, the authentication tag is the authentication credential as described above in process 300.

In some embodiments, first device 302 determines whether second device 304 is an unknown or known device by comparing the authentication response (e.g., one or more values within the authentication response and/or one or more values generated from the authentication response) to a list of one or more stored values. In some embodiments, the list of one or more stored values correspond to data included in previously received authentication responses. For example, first device 302 storing a unique identifier for each device that has connected to first device 302. In some embodiments, first device 302 compares the authentication response to a list of one or more stored values corresponding to known devices. In some embodiments, first device 302 generates a stored value for each known contact stored on first device 302. In some embodiments, first device 302 determines whether second device 304 is an unknown or known device by comparing the authentication response (e.g., one or more values within the authentication response) to one or more values within known contacts of first device 302 (e.g., a unique identifier for each contact and/or one or more fields of a contact page). In some embodiments, first device 302 generates an authentication value for each of first device 302's known contacts and compares the generated authentication value to the authentication response and/or one or more values within the authentication response.

At 712, while connected to second device 304, first device 302 delays subsequent communication with second device 304 due to determining that second device 304 is an unknown device. For example, first device 302 determines second device 304 is an unknown device upon not recognizing the authentication response sent from second device 304, failing to validate the authentication response sent from second device 304, and/or receiving an invalid authentication response from second device 304. In some embodiments, first device 302 delaying subsequent communication with second device 304 is part of one or more processes corresponding to determining that first device 302 has connected to an unknown device. As discussed above in process 300, the process corresponding to unknown devices and/or new devices can include displaying different content, establishing different types of communication channels, and/or sending/requesting different types of information from the device. In some embodiments, first device 302 delays subsequent communication with second device 304 for a predefined amount of time. For example, first device 302 delaying for an amount of time set within first device 302's system settings. In some embodiments, first device 302 delays subsequent communication with second device 304 for a calculated amount of time based on the subsequent communication. For example, first device 302 delaying for an increased and/or decreased amount of time depending on the complexity of and/or privacy or security level corresponding to the subsequent communication.

In some embodiments, first device 302 delaying subsequent communication with second device 304 allows for a user of first device 302 to disconnect from unknown and/or unwanted connections prior to sending and/or displaying additional information (e.g., subsequent communication). For example, first device 302 delaying subsequent communication allows a user of first device 302 the opportunity to pull away and/or move first device 302 away from second device 304 during the delay, disconnecting from the NFC connection to second device 304. Notably, first device 302 delaying subsequent communication allows a user of first device 302 improved security, privacy, and/or control over the user of first device 302's information through the ability to stop unknown and/or unwanted connections before first device 302 displays and/or sends any personal information (e.g., name, contact information, and/or content stored one the device). In some embodiments, prior to and/or during the delay of subsequent communication, first device 302 outputs an indication of the delay and/or an indication of a connection to an unknown device (e.g., sound indication, display indication, and/or haptic indication). For example, upon first device 302 determining that second device 304 is an unknown device, first device 302 outputs a haptic indication to alert a user of first device 302 of the connection.

In some embodiments, an interrupted and/or disconnected connection between first device 302 and another device (e.g., second device 304) returns first device 302 to being able to establish and/or reestablish NFC connections to another device (e.g., second device 304). For example, first device 302 returning to an initial state of being able to establish NFC connections allows a user of first device 302 to easily reestablish a connection to another device (e.g., first device 302) that was mistakenly and/or accidently disconnected. In some embodiments, first device 302 returns to outputting one or more polling messages from an NFC component that is in a lower powered mode (e.g., outputting polling messages at a slower rate).

In some embodiments, first device 302 forgoes delaying the subsequent communication with second device 304 due to determining that second device 304 is a known device. In some embodiments, as discussed above, first device 302 initiates a process corresponding to known devices (e.g., displaying different content, establishing different types of communication channels, and/or sending/requesting different types of information from the device) upon determining that second device 304 is a known device.

At 714, first device 302 sends a validation request to second device 304. In some embodiments, irrespective of whether first device 302 delays, first device 302 sends a validation request to second device 304 to determine whether second device 304 knows first device 302. For example, first device 302 sends the validation request to ensure that both first device 302 and second device 304 have a common experience, as further discussed below. Notably, first device 302 sending the validation request ensures that second device 304 does not forgo displaying a contact sharing user interface when first device 302 does not have contact information corresponding to second device 304, allowing a user of second device 304 to still share contact information even though second device 304 knows first device 302's contact information.

At 716, second device 304 sends a validation response to first device 302. In this example, the validation response sent to first device 302 contains one or more values indicating whether second device 304 knows first device 302. For example, first device 302 obtaining a validation response to the validation request allows first device 302 to display a common experience between first device 302 and second device 304, as discussed below.

In some embodiments, upon first device 302 determining that one or both of a set of communicating devices (e.g., first device 302 and/or second device 304) do not know the corresponding device (e.g., the connected device (e.g., first device 302 and/or second device 304)), the set of communicating devices initiate a process corresponding to unknown devices. In some embodiments, the process corresponding to unknown devices can include displaying a common user interface (e.g., a share contact user interface) between the set of communicating devices, forgoing displaying specific content (e.g., not displaying images, videos, and/or personal information stored on the device), and/or forgoing displaying a share content user interface (e.g., an application and/or user interface that allows for sharing of stored content). For example, first device 302 knows second device 304 but second device 304 does not know first device 302, both devices and/or first device 302 display(s) a share contact information user interface (e.g., see 412, 414, and/or 416 of FIG. 4B). In some embodiments, upon first device 302 receiving contact information from second device 304, first device 302 stores one or more values corresponding to the identification of second device 304 to allow for first device 302 and second device 304 to initiate a process for known devices (e.g., sharing content and/or subsequent communication without a delay), as discussed below.

In some embodiments, upon first device 302 determining that both communicating devices (e.g., first device 302 and/or second device 304) do know the corresponding device (e.g., the connected device (e.g., first device 302 and/or second device 304)), the set of communicating devices initiate a process corresponding to known devices. In some embodiments, the process corresponding to known devices can include displaying specific user interfaces based on current device state (e.g., displaying a share image user interface when an image viewing application is the active application (e.g., see 418 of FIG. 4C)), displaying a share content user interface (e.g., a user interface with recently accesses content that can be shared (e.g., see 418 of FIG. 4C)), and/or a personal information sharing user interface (e.g., a user interface including personal information that can be shared (e.g., location information, address information, and/or other device specific information)). For example, both first device 302 and second device 304 know each other (e.g., first device 302 and second device 304 sending a validation request and/or response corresponding to knowing the other connected device (e.g., first device 302 and/or second device 304)), first device 302 displaying a share content user interface corresponding to an image that first device 302 is displaying, allowing a user of first device 302 to quickly share relevant content to a user of second device 304. In some embodiments, first device 302 does not display additional user interfaces upon validating that both first device 302 and second device 304 know each other. In some embodiments, first device 302 stores the validation to allow a user of first device 302 to share information and/or content, while remaining connected, without requiring the user of second device 304 to confirm the sharing. For example, both first device 302 and second device 304 know each other and first device 302 is displaying a first application, a user of first device 302 may open a second application on first device 302, while remaining connected, and initiate sharing from the second application without confirming sharing.

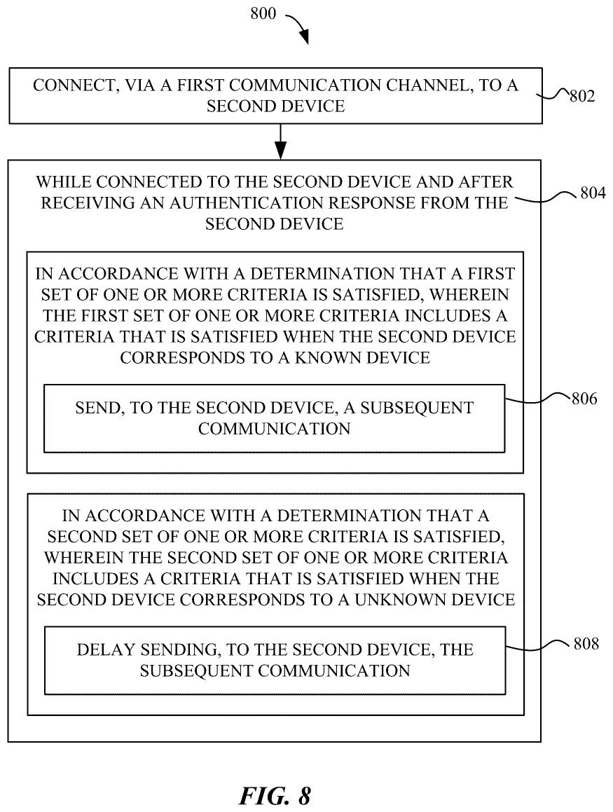

FIG. 8 is a flow diagram illustrating a method (e.g., method 800) for selectively delaying communication in accordance with some embodiments. Some operations in method 800 are, optionally, combined, the orders of some operations are, optionally, changed, and some operations are, optionally, omitted.

As described below, method 800 provides an intuitive way for selectively delaying communication. Method 800 reduces the cognitive burden on a user, thereby creating a more efficient human-machine interface. For battery-operated computing devices, enabling a user to interact with such devices faster and more efficiently conserves power and increases the time between battery charges.

In some embodiments, method 800 is performed at a first device (e.g., a user device and/or a personal device). In some embodiments, the first device is a smart phone, a smart watch, a wearable device, a head-mounted-display (HMD) device, a laptop, a tablet, and/or a desktop computer. In some embodiments, the first device corresponds to a first user.

At 802, the first device connects, via a first communication channel (e.g., a data channel, a data pipe, a near-field-communication (NFC) channel, and/or an NFC data pipe) (e.g., as described above with respect to a communication channel of the second type of method 500), to a second device (e.g., a user device and/or a personal device) different from the first device. In some embodiments, the second device corresponds to a second user different from the first user. In some embodiments, the second device is a smart phone, a smart watch, a wearable device, a head-mounted-display (HMD) device, a laptop, a tablet, and/or a desktop computer. In some embodiments, the first communication channel is not a long term connection.

At 806, while connected to the second device via the first communication channel and after receiving an authentication response (e.g., a certificate, a private credential, a cryptographic credential, data used to authenticate an identity (e.g., of the second device), and/or data indicative of an identity (e.g., of the second device and/or a user account of the second device)) (e.g., corresponding to and/or for the second device and/or a user account of the second device) (e.g., as described above with respect to an authentication credential of method 600) from the second device (e.g., before or while connected via the first communication channel), in accordance with a determination that a first set of one or more criteria is satisfied, wherein the first set of one or more criteria includes a criterion that is satisfied when the second device corresponds to a known device (and/or a user corresponding to the second device is a known user) (and/or that the first device can match the authentication response to an authentication credential known by the first device (e.g., the authentication response corresponding to a stored authentication credential (e.g., locally and/or remotely stored) and/or a generation authentication credential (e.g., authentication credential generated from data stored on the first device))), the first device sends, to the second device, a subsequent communication (e.g., additional authentication response, connection validation response, and/or response corresponding to the first device). In some embodiments, the first device compares the authentication response to a generated authentication credential generated from one or more fields of a contact card stored on the first device. In some embodiments, the first device compares the authentication response to a list of one or more authentication credentials stored on the first device (e.g., corresponding to devices the first device has connected to and received an authentication response from and/or authentication credentials obtained from other forms of connection (e.g., authentication credentials downloaded from a device backup, obtained from a third party, and/or saved from other forms of communication))

At 808, while connected to the second device via the first communication channel and after receiving an authentication response from the second device, in accordance with a determination that a second set of one or more criteria is satisfied, wherein the second set of one or more criteria includes a criterion that is satisfied when the second device corresponds to an unknown device (and/or a user corresponding to the second device is an unknown user) (and/or that the first device cannot match the authentication response to an authentication credential known by the first device (e.g., the first device has not come into contact with the second device before, the first device has an expired authentication credential, and/or the authentication credential known by the first device is invalid and/or corrupt) and/or that the first device cannot decode the authentication response and/or that the authentication response is invalid), the first device delays sending, to the second device, the subsequent communication (e.g., for a predetermined amount of time). In some embodiments, in accordance with a determination that a second set of one or more criteria is satisfied, the first device delays all data transfer to and/or from the second device. In some embodiments, the first device generates the subsequent communication before delaying sending the subsequent communication. In some embodiments, the first device generates the subsequent communication while delaying sending the subsequent communication. In some embodiments, the first device generates the subsequent communication after delaying sending the subsequent communication. In some embodiments, the first device does not send the subsequent communication after losing connection to the second device prior to and/or during the delay. In some embodiments, the predetermined amount of time is fixed and/or set within the first device's settings. In some embodiments, the predetermined amount of time depends on the subsequent communication (e.g., the first device increasing and/or decreasing the length of the delay depending on complexity of the subsequent communication).

In some embodiments, after delaying sending, to the second device, the subsequent communication and in accordance with a determination that the second device remains connected (e.g., is connected, is still connected, and/or continues to be connected) to the first device, the first device sends, via the first communication channel, the subsequent communication. In some embodiments, after delaying sending, to the second device, the subsequent communication and in accordance with a determination that the second device is no longer connected to the first device, the first device forgoes sending, via the first communication channel, the subsequent communication. In some embodiments, the first device determines that the second device remains connected by maintaining a proximity-based connection (e.g., first device and second device remain sufficiently close together for a NFC component and/or receiver to remain connected and/or detected).

In some embodiments, after sending, via the first communication channel, the subsequent communication, the first device establishes, based on (and/or using) content (e.g., a communication type value (and/or corresponding to a type of communication channel desired for another communication channel (e.g., a second communication channel)) (e.g., Wi-Fi, Bluetooth, alternative proximity based communication channel types, and/or alternative non-proximity based communication channel types)) included in the authentication response, a second communication channel (e.g., Wi-Fi and/or Bluetooth) different (and/or separate) from the first communication channel. In some embodiments, the second communication channel is a different type of communication channel than the first communication channel. In some embodiments, the first communication channel is of a type to allow for only proximity-based communication. In some embodiments, the first communication channel is automatically disconnected by moving the first device and/or the second device away from each other. In some embodiments, the second communication channel is of a type to allow for proximity-based and/or non-proximity-based communication. In some embodiments, the second communication channel provides continued communication at a distance greater than enabled by proximity-based communication and/or the first communication channel. In some embodiments, establishing the second communication channel ends and/or disconnects the first communication channel and/or stops enabling communication over the first communication channel. In some embodiments, the first communication channel remains available while connected via the second communication channel. In some embodiments, the first communication channel remains available while the first device and the second device remain sufficiently close together to allow proximity-based communication. In some embodiments, the communication type value is a value corresponding to the type of communication channel to establish after the subsequent communication is sent. In some embodiments, the communication type value indicates that the communication channel is of a first type and/or a second type as described above in method 500.

In some embodiments, the subsequent communication is (and/or includes) a validation request (e.g., a request for the second device to validate information and/or confirm that the first device is a known device for the second device). In some embodiments, the validation request includes an indication of whether the second device (and/or another device different from the first device and the second device) is a known device (e.g., whether the first device and/or a device (e.g., different from the first device and the second device) in communication with the first device knows (and/or has stored information corresponding to and/or has previously communicated with) the second device). In some embodiments, the indication of whether the second device (and/or the other device) is a known device is a Boolean value corresponding to the first device successfully identifying the second device (and/or the other device) or failing to identify the second device (and/or the other device). In some embodiments, the criterion that is satisfied when the second device corresponds to the known device is satisfied when the indication is a positive indication that the second device is a known device. In some embodiments, in response to, in conjunction with, and/or after determining that the second device is an unknown device, the first device sets the indication of the validation request as failing to identify the second device (e.g., the second device is an unknown device). In some embodiments, while and/or after delaying sending the subsequent communication, the first device sets the indication of the validation request as failing to identify the second device (e.g., the second device is an unknown device).

In some embodiments, the first device is in communication with a display generation component. In some embodiments, after sending, via the first communication channel, the subsequent communication, the first device receives, from the second device, a validation response (e.g., a response to the validation request). In some embodiments, the validation response includes an indication of whether the first device (and/or another device different from the first device and the second device) is a known device (e.g., whether the second device and/or a device (different from the first device) in communication with the second device knows (and/or has stored information corresponding to and/or has previously communicated with) the first device). In some embodiments, the indication of whether the first device is a known device is a Boolean value corresponding to the second device successfully identifying the first device or failing to identify the first device. In some embodiments, in response to receiving the validation response, in accordance with a determination that a third set of one or more criteria is satisfied, wherein the third set of one or more criteria includes a criterion that is satisfied when the validation response includes an indication that the second device successfully identified (and/or knows) the first device, the first device displays, via the display generation component, a first user interface. In some embodiments, the first user interface corresponds to additional functionality available when communicating with known devices (e.g., sharing content (e.g., pictures, videos, and/or other stored content) and/or sharing additional information (e.g., addresses, information from specific applications, and/or device information)). In some embodiments, the first user interface corresponds to an active application (e.g., a share image user interface when an image viewer is active and/or a share destination user interface when a navigation application is active). In some embodiments, in response to receiving the validation response, in accordance with a determination that a fourth set of one or more criteria is satisfied, wherein the fourth set of one or more criteria includes a criterion that is satisfied when the validation response includes an indication that the second device did not successfully identify (and/or does not know) the first device, the first device displays, via the display generation component, a second user interface different from the first user interface, wherein the fourth set of one or more criteria is different from the third set of one or more criteria. In some embodiments, the second user interface corresponds to limited functionality available when communicating with unknown devices (e.g., sharing contact information). In some embodiments, after displaying the second user interface, the first user interface can be displayed (e.g., after sharing contact information the first device and second device know each other and can enable additional information). In some embodiments, while and/or after the second user interface is displayed, cancelling and/or terminating the second user interface causes the second device to remain unknown.

In some embodiments, the validation response includes an indication of whether the first device is a known device (e.g., whether the second device and/or a device (e.g., different from the first device and the second device) in communication with the second device knows (and/or has stored information corresponding to and/or has previously communicated with) the first device). In some embodiments, the indication of whether the first device is a known device is a Boolean value corresponding to the second device successfully identifying the first device or failing to identify the first device.

In some embodiments, in response to receiving the validation response, in accordance with a determination that a fifth set of one or more criteria is satisfied, wherein the fifth set of one or more criteria includes a criterion that is satisfied when either (e.g., but not both) the first device or the second device is a known device (e.g., either the validation request or the validation response includes an indication that a device is a known device) and either (e.g., but not both) the first device or the second device is an unknown device (e.g., either the validation request or the validation response includes an indication that a device is an unknown device), the first device displays, via the display generation component, a third user interface. In some embodiments, the fifth set of one or more criteria is different from the third set of one or more criteria and/or the fourth set of one or more criteria. In some embodiments, in response to receiving the validation response, in accordance with a determination that a sixth set of one or more criteria is satisfied, wherein the sixth set of one or more criteria includes a criterion that is satisfied when both the first device and the second device are unknown devices (e.g., both the validation request and the validation response include an indication that a device is an unknown device), the first device displays, via the display generation component, the third user interface, wherein the sixth set of one or more criteria is different from the fifth set of one or more criteria. In some embodiments, the sixth set of one or more criteria is different from the third set of one or more criteria and/or the fourth set of one or more criteria. In some embodiments, in response to receiving the validation response, in accordance with a determination that a seventh set of one or more criteria is satisfied, wherein the seventh set of one or more criteria includes a criterion that is satisfied when both the first device and the second device are known devices (e.g., both the validation request and the validation response include an indication that a device is a known device), the first device displays, via the display generation component, a fourth user interface (e.g., the first user interface) different from the third user interface. In some embodiments, the third user interface includes one or more user interface elements that enable sharing of device-based, user-based, and/or application-based information (e.g., including a user interface element for sharing contact information and/or a unique identifier for the user account associated with the device (e.g., the first device and/or the second device)). In some embodiments, the third user interface corresponds to limited functionality associated with communication with unknown devices (e.g., not displaying personal information and/or enabling sharing of personal information).

In some embodiments, the subsequent communication is a request to connect via a third communication channel (and/or a wireless communication channel) (e.g., a short-range wireless communication channel) (e.g., the second communication channel) (e.g., Wi-Fi or Bluetooth) different from the first communication channel.

In some embodiments, the authentication response is received via the first communication channel. In some embodiments, while connected to the second device via the first communication channel and before receiving the authentication response, the first device sends, to the second device, an authentication request, via the first communication channel. In some embodiments, the authentication request includes a set of one or more values corresponding to the first device. In some embodiments, the authentication request is sent in response to connecting to the second device. In some embodiments, the authentication request and/or the authentication response include information required to establish another communication channel (e.g., one or more values required to establish a network-based connection between the first device and the second device).

In some embodiments, the authentication request includes a unique identifier to establish a fourth communication channel. In some embodiments, the unique identifier corresponds to the first device. In some embodiments, the unique identifier is used for identifying the first device for connection purposes (e.g., identifying the first device in a list of one or more devices within Bluetooth range and/or identifying the first device in a list of one or more device connected on the same wireless network).

In some embodiments, the authentication request includes a first identifier (e.g., an authentication tag and/or cryptographic checksum) corresponding to (and/or usable to identify and/or of) the first device. In some embodiments, the first identifier and the unique identifier are different identifiers. In some embodiments, the first identifier is used for security purposes rather than communication purposes (e.g., recognizing another device (e.g., the second device) that is a member of the same organization and/or recognizing another device (e.g., the second device) connected to a certain contact stored on the first device).

In some embodiments, the authentication response includes a second identifier (e.g., an authentication tag and/or cryptographic checksum) corresponding to (and/or usable to identify and/or of) the second device. In some embodiments, the second identifier is used for establishing another communication channel. In some embodiments, the second identifier is used for identifying the second device for connection purposes (e.g., identifying the second device in a list of one or more devices within Bluetooth range and/or identifying the second device in a list of one or more device connected on the same wireless network).

In some embodiments, the criterion that is satisfied when the second device corresponds to a known device includes a determination that the second identifier matches a third identifier (e.g., stored by the first device). In some embodiments, the criterion that is satisfied when the second device corresponds to an unknown device includes a determination that the second identifier does not match an identifier stored by the first device. In some embodiments, the third identifier is stored by the first device in a list of one or more identifiers. In some embodiments, the third identifier is a previously stored identifier, indicating that the first device and the second device have been in communication before and exchanged identifiers. In some embodiments, the first device utilizes one or more values stored on the first device as the third identifier. In some embodiments, the first device generates the third identifier while connected to the second device via the first communication channel and/or after receiving the authentication response. In some embodiments, the second identifier matching the third identifier indicates that the second device has previously shared an identifier with the first device (e.g., through initiating and/or completing connection as depicted and/or through sharing an identifier with the first device and/or second device through other methods of sharing (e.g., sending contact information, downloading a contact card, and/or downloading a list of identifiers as part of an organization directory)). In some embodiments, the second identifier not matching an identifier stored by the first device indicates that the first device failed to identify the second device (e.g., unable to match the second identifier with an identifier stored in a list of one or more identifies on the first device). In some embodiments, in conjunction with (e.g., in response to and/or after) the first device failing to match the second identifier with an identifier stored by the first device, the first device stores the second identifier.

In some embodiments, the authentication response includes a set of one or more values (and/or corresponding to the second device). In some embodiments, the third identifier is generated by the first device based on (and/or using) the set of one or more values. In some embodiments, the set of one or more values correspond to the second device (e.g., unique device identifier, device name, connected user account information (e.g., contact name associate with the device, real name of a present user, and/or unique account identifier), public and/or private keys, and/or timestamp). In some embodiments, the first device generates the third identifier based on the type of device, communication, and/or transaction (e.g., currently open application, location of the first device, and/or external conditions).

In some embodiments, the authentication response includes a unique identifier to establish a fifth communication channel (e.g., Wi-Fi and/or Bluetooth). In some embodiments, the unique identifier corresponds to the second device. In some embodiments, the unique identifier is used for identifying the second device for connection purposes (e.g., identifying the second device in a list of one or more devices within Bluetooth range and/or identifying the second device in a list of one or more device connected on the same wireless network).

In some embodiments, the first communication channel is an NFC channel (e.g., a data channel, a data pipe, a near-field-communication (NFC) channel, and/or an NFC data pipe) established via a near-field communication (NFC) component. In some embodiments, the NFC channel functions as described in method 500 and/or method 600.

In some embodiments, while the NFC component is operating in a lower power mode (e.g., low power card detection (LPCD) mode) and before sending the authentication request via the first communication channel, the first device detects, via the NFC component, a receiver (e.g., the second device and/or a receiver corresponding to and/or of the second device). In some embodiments, in response to detecting the receiver, the first device changes the NFC component to a higher power mode before sending the authentication request to the second device. In some embodiments, the NFC component operating in the higher power mode includes the NFC component outputting at a greater polling rate, intensity, and/or range. In some embodiments, in response to no longer detecting the receiver, the NFC component and/or the first device causes the NFC component to revert back to the lower power mode.

In some embodiments, detecting the receiver includes: receiving a communication including one or more random numbers; and comparing the one or more random numbers received in the communication to one or more random numbers generated by the first device. In some embodiments, comparing the one or more random numbers enables the first device and/or the second device to determine whether to initiate NFC based communication (e.g., as discussed above with respect to method 500).

Note that details of the processes described above with respect to method 800 (e.g., FIG. 8) are also applicable in an analogous manner to the methods described herein. For example, method 800 optionally includes one or more of the characteristics of the various methods described herein with reference to method 500. For example, the first communication channel of method 800 can be the first communication channel of the first type of method 500. For brevity, these details are not repeated herein.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve how a device interacts with a user. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to authentication another device prior to communicate data. Accordingly, use of such personal information data enables improved security, privacy, and/or control over the user's personal information. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

What is claimed is:

1. A method, comprising:
at a first device:
connecting, via a first communication channel, to a second device different from the first device; and
while connected to the second device via the first communication channel and after receiving an authentication response from the second device:
in accordance with a determination that a first set of one or more criteria is satisfied, wherein the first set of one or more criteria includes a criterion that is satisfied when the second device corresponds to a known device, sending, to the second device, a subsequent communication; and
in accordance with a determination that a second set of one or more criteria is satisfied, wherein the second set of one or more criteria includes a criterion that is satisfied when the second device corresponds to an unknown device, delaying sending, to the second device, the subsequent communication.

2. The method of claim 1, further comprising:
after delaying sending, to the second device, the subsequent communication and in accordance with a determination that the second device remains connected to the first device, sending, via the first communication channel, the subsequent communication.

3. The method of claim 2, further comprising:
after sending, via the first communication channel, the subsequent communication, establishing, based on content included in the authentication response, a second communication channel different from the first communication channel.

4. The method of claim 1, wherein the subsequent communication is a validation request, and wherein the validation request includes an indication of whether the second device is a known device.

5. The method of claim 4, wherein the first device is in communication with a display generation component, the method further comprising:
after sending, via the first communication channel, the subsequent communication, receiving, from the second device, a validation response; and
in response to receiving the validation response:
in accordance with a determination that a third set of one or more criteria is satisfied, wherein the third set of one or more criteria includes a criterion that is satisfied when the validation response includes an indication that the second device successfully identified the first device, displaying, via the display generation component, a first user interface; and
in accordance with a determination that a fourth set of one or more criteria is satisfied, wherein the fourth set of one or more criteria includes a criterion that is satisfied when the validation response includes an indication that the second device did not successfully identify the first device, displaying, via the display generation component, a second user interface different from the first user interface, wherein the fourth set of one or more criteria is different from the third set of one or more criteria.

6. The method of claim 5, wherein the validation response includes an indication of whether the first device is a known device.

7. The method of claim 5, further comprising:
in response to receiving the validation response:
in accordance with a determination that a fifth set of one or more criteria is satisfied, wherein the fifth set of one or more criteria includes a criterion that is satisfied when either the first device or the second device is a known device and either the first device or the second device is an unknown device, displaying, via the display generation component, a third user interface;
in accordance with a determination that a sixth set of one or more criteria is satisfied, wherein the sixth set of one or more criteria includes a criterion that is satisfied when both the first device and the second device are unknown devices, displaying, via the display generation component, the third user interface, wherein the sixth set of one or more criteria is different from the fifth set of one or more criteria; and
in accordance with a determination that a seventh set of one or more criteria is satisfied, wherein the seventh set of one or more criteria includes a criterion that is satisfied when both the first device and the second device are known devices, displaying, via the display generation component, a fourth user interface different from the third user interface.

8. The method of claim 1, wherein the subsequent communication is a request to connect via a third communication channel different from the first communication channel.

9. The method of claim 1, wherein the authentication response is received via the first communication channel, the method further comprising:
while connected to the second device via the first communication channel and before receiving the authentication response, sending, to the second device, an authentication request, via the first communication channel.

10. The method of claim 9, wherein the authentication request includes a unique identifier to establish a fourth communication channel.

11. The method of claim 9, wherein the authentication request includes a first identifier corresponding to the first device.

12. The method of claim 1, wherein the authentication response includes a second identifier corresponding to the second device.

13. The method of claim 12, wherein the criterion that is satisfied when the second device corresponds to a known device includes a determination that the second identifier matches a third identifier, and wherein the criterion that is satisfied when the second device corresponds to an unknown device includes a determination that the second identifier does not match an identifier stored by the first device.

14. The method of claim 13, wherein the authentication response includes a set of one or more values, and wherein the third identifier is generated by the first device based on the set of one or more values.

15. The method of claim 12, wherein the authentication response includes a unique identifier to establish a fifth communication channel.

16. The method of claim 1, wherein the first communication channel is an NFC channel established via a near-field communication component.

17. The method of claim 16, further comprising:
while the NFC component is operating in a lower power mode and before sending the authentication request via the first communication channel, detecting, via the NFC component, a receiver; and
in response to detecting the receiver, changing the NFC component to a higher power mode before sending the authentication request to the second device.

18. The method of claim 17, wherein detecting the receiver includes:
receiving a communication including one or more random numbers; and
comparing the one or more random numbers received in the communication to one or more random numbers generated by the first device.

19. A non-transitory computer-readable storage medium storing one or more programs configured to be executed by one or more processors of a first device, the one or more programs including instructions for:
connecting, via a first communication channel, to a second device different from the first device; and
while connected to the second device via the first communication channel and after receiving an authentication response from the second device:
in accordance with a determination that a first set of one or more criteria is satisfied, wherein the first set of one or more criteria includes a criterion that is satisfied when the second device corresponds to a known device, sending, to the second device, a subsequent communication; and
in accordance with a determination that a second set of one or more criteria is satisfied, wherein the second set of one or more criteria includes a criterion that is satisfied when the second device corresponds to an unknown device, delaying sending, to the second device, the subsequent communication.

20. A first device, comprising:
one or more processors; and
memory storing one or more programs configured to be executed by the one or more processors, the one or more programs including instructions for:
connecting, via a first communication channel, to a second device different from the first device; and
while connected to the second device via the first communication channel and after receiving an authentication response from the second device:
in accordance with a determination that a first set of one or more criteria is satisfied, wherein the first set of one or more criteria includes a criterion that is satisfied when the second device corresponds to a known device, sending, to the second device, a subsequent communication; and
in accordance with a determination that a second set of one or more criteria is satisfied, wherein the second set of one or more criteria includes a criterion that is satisfied when the second device corresponds to an unknown device, delaying sending, to the second device, the subsequent communication.
